(19) United States
(12) Patent Application Publication
(10) Pub. No.: US 2013/0246283 A1
(43) Pub. Date: Sep. 19, 2013

(54) PRINTED MATERIAL CREATION SUPPORT APPARATUS, METHOD, AND CARRIER MEDIUM

(71) Applicant: Daisuke SUGIMOTO, Tokyo (JP)

(72) Inventor: Daisuke SUGIMOTO, Tokyo (JP)

(21) Appl. No.: 13/845,848

(22) Filed: Mar. 18, 2013

(30) Foreign Application Priority Data
Mar. 19, 2012 (JP) 2012-061438
Mar. 19, 2012 (JP) 2012-061441

(51) Int. Cl. G06Q 10/10

(52) U.S. Cl. CPC G06Q 10/101
USPC 705/300

(57) ABSTRACT

A printed material creation support apparatus is disclosed. In printed material creation support apparatus, a user interface providing part provides an input user interface to a client. A design partner selection part selects a design partner in multiple design partners based on created material information of the client. An estimation process part sends apercu created material information defining a requirement of the created material to the design partner, receives estimation result information of the design partner, and sends the estimation result information to the client. A consensus settlement support part settles consensus based on the estimation confirmation information received from the client. A design modification part synchronously reflects modifications of the design partner with a modification indication of the client with respect to design information created based on detailed created material information after the consensus is settled and defines a detailed requirement being more than the apercu created material information.

### BACKGROUND OF THE INVENTION

1. Field of the Invention

The disclosure herein relate to a printed material creation support apparatus, a printed material creation support method, and carrier medium, and more particularly to the printed material creation support apparatus, the printed material creation support method, and the carrier medium, which support creation of a printed material from a design to a printed output.

2. Description of the Related Art

Recently, a concept of cloud computing has been advocated. It is considered that the concept includes a new use aspect in which a user uses services and computer resources in a virtual space at an other side of a network as necessary as the user desires.

In a technical field of publication and commercial printing using a computer, there is a step in which an original created by a writer, a photographer, an editor, and the like is processed, designed, and finished by a professional person, a so-called “designer”. In order to retain quality suitable for mass publication and commercial use, since a professional technique and knowledge are required for each step, each step is specialized.

For small and medium-sized enterprises and individuals which are lacking in funds, but who desire to create printed materials described above such as a “document of a professional specification”, it is not simple to match each of them with requisite professionals. However, there has not been provided an intermediary system for the small and medium-sized enterprises and individuals who are unfamiliar with the technical fields of publishing and commercial printing using computers to easily create the “document of the professional specification”.

Even in a case in which an enterprise of the user is large scale, if the printed material is targeted to specific customers and is to be distributed with a small volume of copies, it is difficult for a print agent to provide that service with a price justifying the a cost. Hence, in practice, the print agent is unwilling to contract to provide that service.

Patent Document 1 discloses a system for pairing a design and a designer. In the system, a competition is conducted based on data input by a user, among multiple designers. The user selects one of designs from results presented by the multiple designers.

However, in the above described related art, there may be the following problems.

When a design is determined, there is no problem when a customer is familiar with information necessary to create a design and information necessary for the designer, but in general, the customer himself or herself does not have high competency pertaining to a design creation. It is anticipated that the designer may not have acquired sufficient information to create the design. If a design competition is conducted based on initial information input by the customer, the design desired by the customer is potentially not acquired at all. Also, the designer loses a significance of the design creation. Hence, there is a concern that both the customer and the designer may have a disadvantage.

In order to prevent an occurrence of the disadvantage, instead of a scheme for the customer to select one of completed designs, it is preferable to provide a system which intermediates a scheme for proceeding the design creation after passing a stage for an agreement concerning a sales order and purchase order between the customer and the designer based on an estimate and a rough design.

Moreover, conventionally, it has been difficult concerning how to communicate with a creator for inexplicit information such as the design. Due to characteristics of a created material of which an image varies depending on an aspect of the design comprehended by the creator, it is not easy to bridge a gap between an idea of the customer and the aspect of the creator. If the user is only allowed to input the information once, it may often occur a situation where the idea the customer intended is not designed. In the conventional competition method, these varying factors are simply compensated with a large number of creators. Each of the creators simply creates the design in accordance with an initial condition input by the customer. Only after the creator is selected, the creator knows the design which the customer intended.

### Patent Document

Patent Document 1: Japanese Laid-open Patent Publication No. 2002-150033

Accordingly, it is a general object of at least one embodiment of the present invention to provide a printed material creation support apparatus in which the consensus is achieved after multiple stages between a client and a designer and the printed material of the design which satisfies the client is acquired, which substantially eliminates one or more problems caused by the limitations and disadvantages of the related art.

### SUMMARY OF THE INVENTION

In one aspect of this disclosure, there is provided a printed material creation support apparatus including a user interface providing part configured to provide an input user interface to a client; a design partner selection part configured to select a first design partner from multiple design partners based on created material information which the client inputs to the input user interface; an estimation process part configured to send apercu created material information defining a first requirement of the created material to the first design partner selected by the design partner selection part, to receive estimation result information made by the first design partner, and to send the estimation result information to the client; a consensus settlement support part configured to receive estimation confirmation information from the client and to settle consensus based on the estimation confirmation information; and a design modification part configured to synchronously reflect modifications of the first design partner with a modification indication of the client with respect to design information created based on detailed created material information which is received from the client after the consensus is settled for an estimation and defines a first detailed requirement which is more than the apercu created material information.

In one aspect of this disclosure, there is provided a printed material creation support method performed in a computer, the method including providing an input user interface to a client; selecting a first design partner from multiple design partners based on created material information which the client inputs to the input user interface; sending apercu created material information defining a first requirement of the created material to the first design partner being selected, receiving estimation result information made by the first design partner, and sending the estimation result information to the client; receiving estimation confirmation information from the client and settling consensus based on the estimation confirmation information; and synchronously reflecting modifications of the first design partner with a modification indication of the client with respect to design information created based on detailed created material information which is received from the client after the consensus is settled for an estimation and defines a first detailed requirement which is more than the apercu created material information.

In one aspect of this disclosure, there is provided a carrier medium saving a program representing a sequence of instructions, the program which when executed by a computer included in a printed material creation support apparatus, supports creation of a printed material, the instruction causes the computer to functions as a user interface providing unit which provides an input user interface to a client; a design partner selection unit which selects a first design partner from multiple design partners based on created material information which the client inputs to the input user interface; an estimation process unit which sends apercu created material information defining a first requirement of the created material to the first design partner being selected, receiving estimation result information made by the first design partner, and sending the estimation result information to the client; a consensus settlement support unit which receives estimation confirmation information from the client and settling consensus based on the estimation confirmation information; and a design modification unit which synchronously reflecting modifications of the first design partner with a modification indication of the client with respect to design information created based on detailed created material information which is received from the client after the consensus is settled for an estimation and defines a first detailed requirement which is more than the apercu created material information.

Additional objects and advantages of the embodiments will be set forth in part in the description which follows, and in part will be obvious from the description, or may be learned by practice of the invention.

It is to be understood that both the foregoing general description and the following detailed description are exemplary and explanatory only and are not restrictive of the invention as claimed.

### BRIEF DESCRIPTION OF THE DRAWINGS

Other objects and further features of embodiments will be apparent from the following detailed description when read in conjunction with the accompanying drawings, in which:

FIG. 1 is a diagram illustrating a brief network configuration in an embodiment (part 1);

FIG. 2 is a diagram illustrating a brief network configuration in the embodiment (part 2);

FIG. 3 is a diagram illustrating a functional configuration in the embodiment;

FIG. 4 is a diagram for explaining a flow of an information process in the embodiment (part 1);

FIG. 5 is a diagram for explaining a flow of the information process in the embodiment (part 2);

FIG. 6 is a diagram for explaining a flow of the information process in the embodiment (part 3);

FIG. 7 is a diagram for an example of a request information (or created material information) input screen in the embodiment;

FIG. 8 is a diagram illustrating an example of a content confirmation screen of an estimation request in the embodiment;

FIG. 9 is a diagram illustrating an example of an estimation confirmation screen in the embodiment;

FIG. 10 is a diagram illustrating an example of a selection result confirmation screen in the embodiment; and

FIG. 11 is a diagram illustrating an example of a real time communication support screen in the embodiment.

### DESCRIPTION OF THE PREFERRED EMBODIMENTS

Preferred embodiments are described below, with reference to the accompanying drawings.

### [System Configuration]

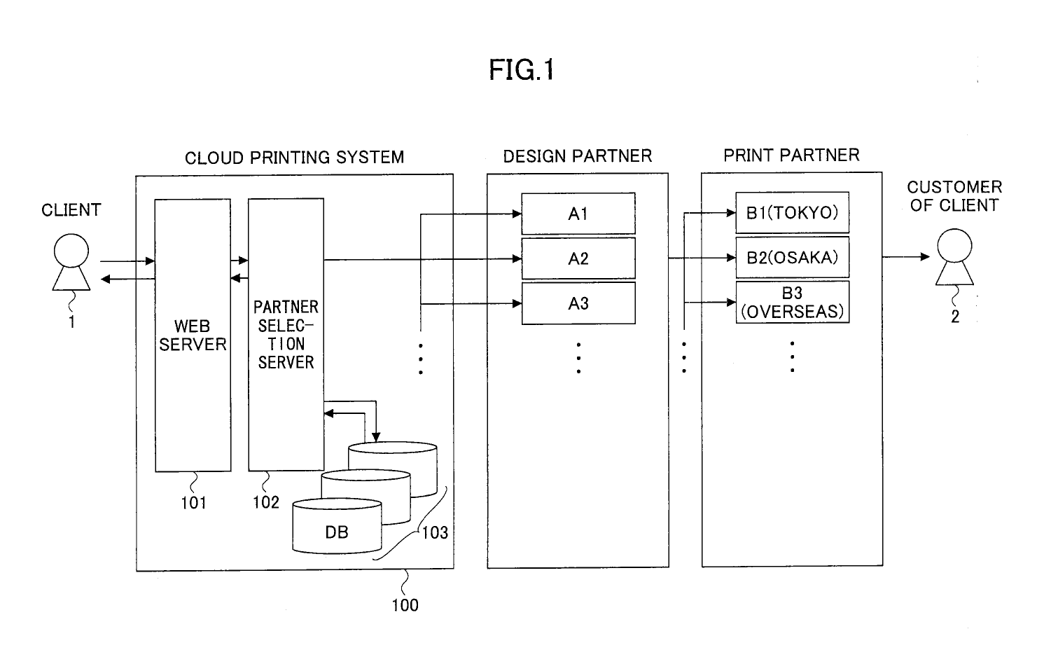

FIG. 1 is a diagram briefly illustrating a network configuration according to an embodiment from a viewpoint of an infrastructure layer. As illustrated in FIG. 1, a cloud printing system 100 according to the embodiment intermediates between a client 1 as a user of the cloud printing system 100 and a customer 2 of the client 1, and is regarded as a computer system for supporting communications between them. That is, the cloud printing system 100 supports the client 1 to communicate specialists such as design partners A1, A2, A3, . . . (hereinafter, called design partners Ai), print partners B1, B2, B3, . . . (hereinafter, called print partners Bi), and the like and to use equipment meanwhile a printed material is delivered to the customer 2 of the client 1.

Especially, the cloud printing system 100 supports the client 1 to select one of the design partners Ai. Thus, within the cloud printing system 100, at least a web server 101 and a partner selection server 102 are included. The partner selection server 102 accesses storage as databases (DB) 103 which stores information pertinent to the design partners Ai. Also, it is possible to access another storage used to store the printed materials for a selection of one of the design partners Ai or after one of the design partners Ai is selected.

The infrastructure illustrated in FIG. 1 is an example of a case in which the cloud printing system 100 is implemented as a Web application. Each of functions in the embodiment described below may be realized, instead of using the web server 101 and an application server.

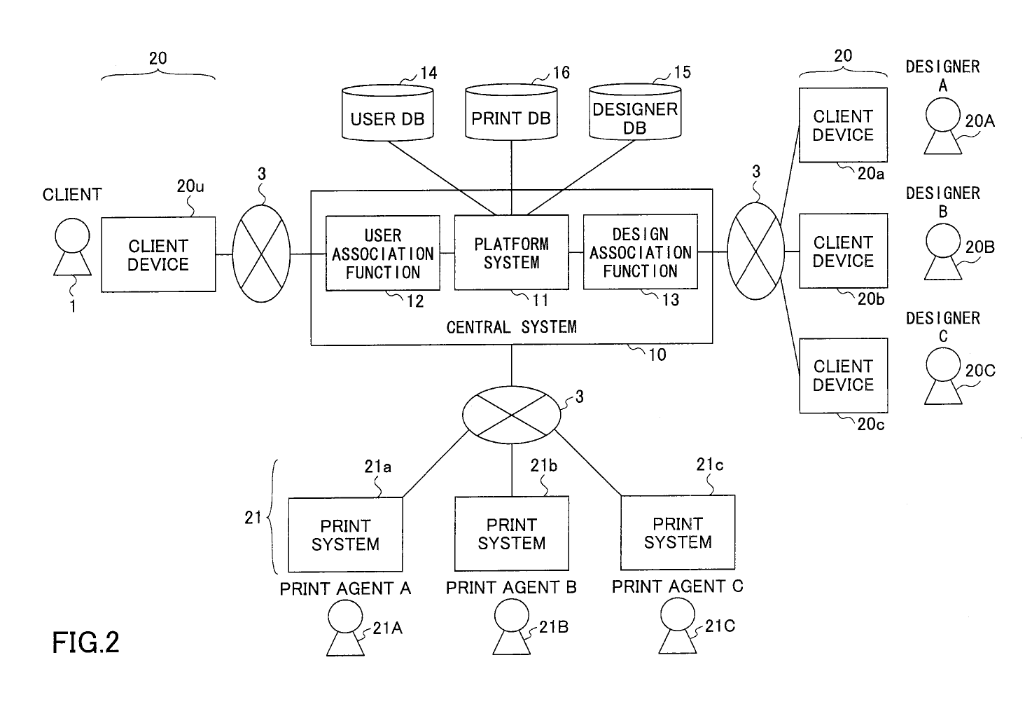

FIG. 2 is a diagram briefly illustrating a network configuration in the embodiment from a viewpoint of an application layer. From the viewpoint of the application layer, that is, a functional configuration, when the cloud printing system 100 is considered in a relationship between the client 1 and the design partners Ai, and a relationship between the design partners Ai and the print partners Bi, the cloud printing system 100 is regarded as a central system 10 which connects between the design partners Ai and the print partners Bi. The central system 10 corresponds to a printed material creation support apparatus.

The central system 10 is used to connect between the client 1 of the cloud printing system 100 and the design partners Ai, and between the design partners Ai and the print partners Bi, and functions as a printed material creation support system. Each of functions of the central system 10 may be realized by information processes conducted by one or more general-purpose computer. The central system 10 includes a platform system 11, a user association function 12, a design association function 13 as functions.

The platform system 11 conducts connectivity to each of various databases in the cloud printing system 100. As the various databases, a user database 14, a designer database 15, and a print database 16 are provided.

The user database 14 stores information of the client 1 who is the user of the cloud printing system 100 and is an orderer for the designer. The database 15 stores information of the design partners Ai who are the designers registered to the cloud printing system 100.

The print database 16 stores electronic data of the printed materials designed by the design partners Ai. Design information, which is created during interactions between the client 1 and the design partners Ai, is stored as the electronic data. The print partners Bi may access the electronic data when they are permitted. The design information is proofed. Any of the print partners Bi, who satisfies conditions such as supporting a file format and the like, is capable of printing out the design information, regardless of his/her location in a physical space.

In the print database 16, the electronic data of the design information being proofed are stored in a storage area which is called “MY BOX” allotted for each of the clients 1. Any one of the design partners Ai, who makes a design service contract with the client 1 through a formal ordering procedure, can upload the electronic data of the design information being proofed into MY BOX. Also, when making a print output service contract with the client 1, the print partners Bi can download the electronic data of the design information being proofed, to print systems 21 respective to the print partners Bi. The print database 16 includes a function for receiving a download request of the electronic data externally from the print systems 21.

The client 1 connects to the central system 10 by client devices 20u through a network 3, and each of designers 20A, 20B, and 20C connect to the central system 10 by client devices 20 through the network 3. As the client devices 20, a personal computer is typically used. Also, a smart device, a so-called “smart phone”, which has a slate shape including a touch pad for an operation, may be used. The client devices 20u is the client device 20 used by the client 1. The client device 20 which the designer 20A uses is called a “client device 20a”. The client device 20 which the designer 20B uses is called a “client device 20b”. The client device 20 which the designer 20C uses is called a “client device 20c”.

The user association function 12 outputs a user interface and information to display in the user interface at the client device 20u. The design association function 13 outputs a user interface and information to display in the user interface at the client devices 20a, 20b, and 20c, and inputs information input based on the user interface to the central system 10.

As a specific example of intermediating information between the user association function 12 and the design association function 13, an electronic mail may be used.

Each of the print systems 21 is regarded as a computer system which includes a print image forming apparatus used when each of print agents prints out. The print systems 21 includes a print system 21a of a print agent 21A, a print system 21b of a print agent 21B, and a print system 21c of a print agent 21C. Each of the print systems 21 includes an interface accessible to the print database 16. Each of the print systems 21 also includes a function for downloading and printing out the electronic data stored in the print database 16.

The platform system 11 conducts an information process input and output from the user association function 12 and the design association function 13, and information input and output by accessing each of the various databases including databases 14, 15, and 16. At least, the information process includes a process for matching the client 1 to one of the design partners Ai (a design partner selection process).

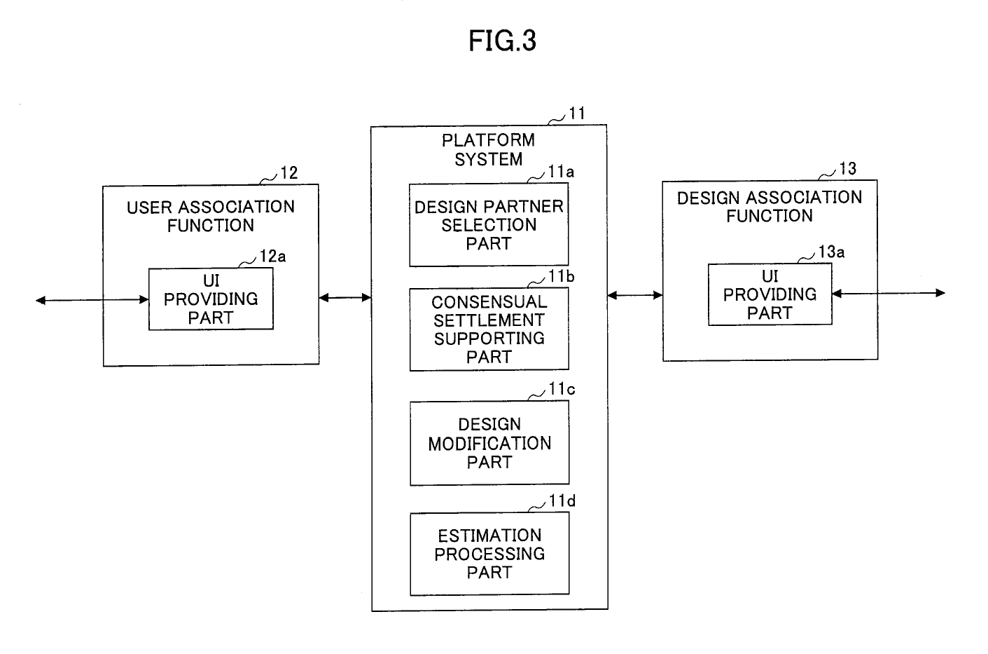

FIG. 3 is a diagram illustrating a functional configuration provided by the platform system 11, the user association function 12, and the design association function 13. As illustrated in FIG. 3, the user association function 12 includes a user interface (UI) providing part 12a, and the design association function 13 includes a user interface (UI) providing part 13a. The platform system 11 includes a design partner selection part 11a, a consensual settlement supporting part 11b, a design modification part 11c, and an estimation processing part 11d.

Each of the functions illustrated in FIG. 3 realizes a design partner selection, and an association with printing.

### [Information Process]

In the following, a flow of the information process by the central system 10 will be described. In the embodiment, an order of the client 1 being the originator is conducted by three stages: (1) design partner determination, (2) estimation determination, and (3) detailed design review, to proof a design. In addition, a stage of (4) association of design creation and printing is conducted.

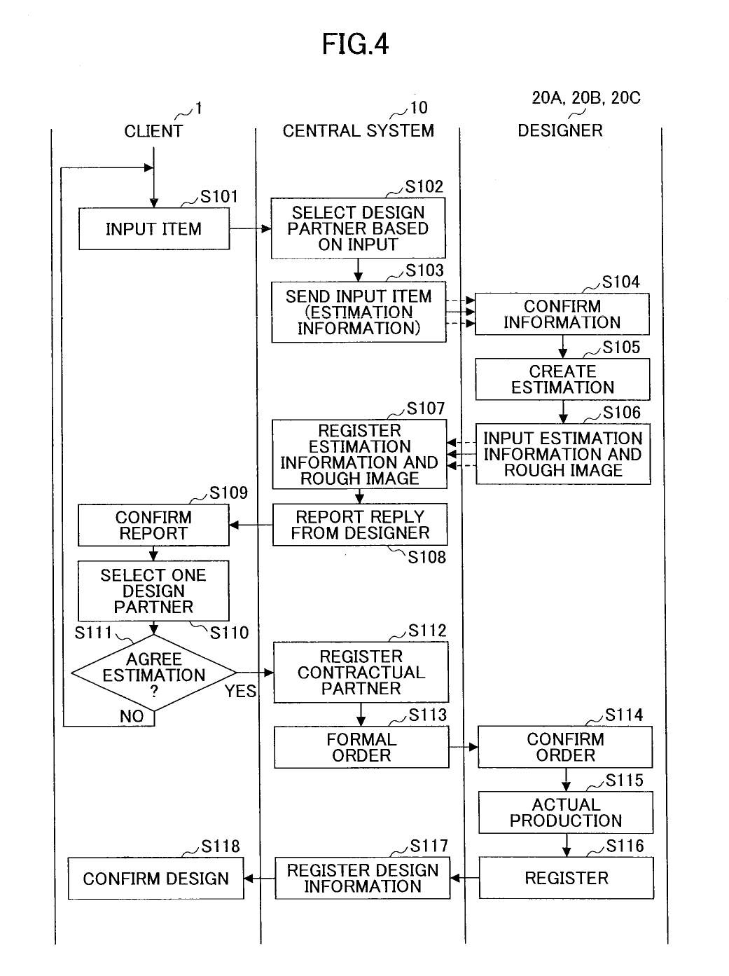

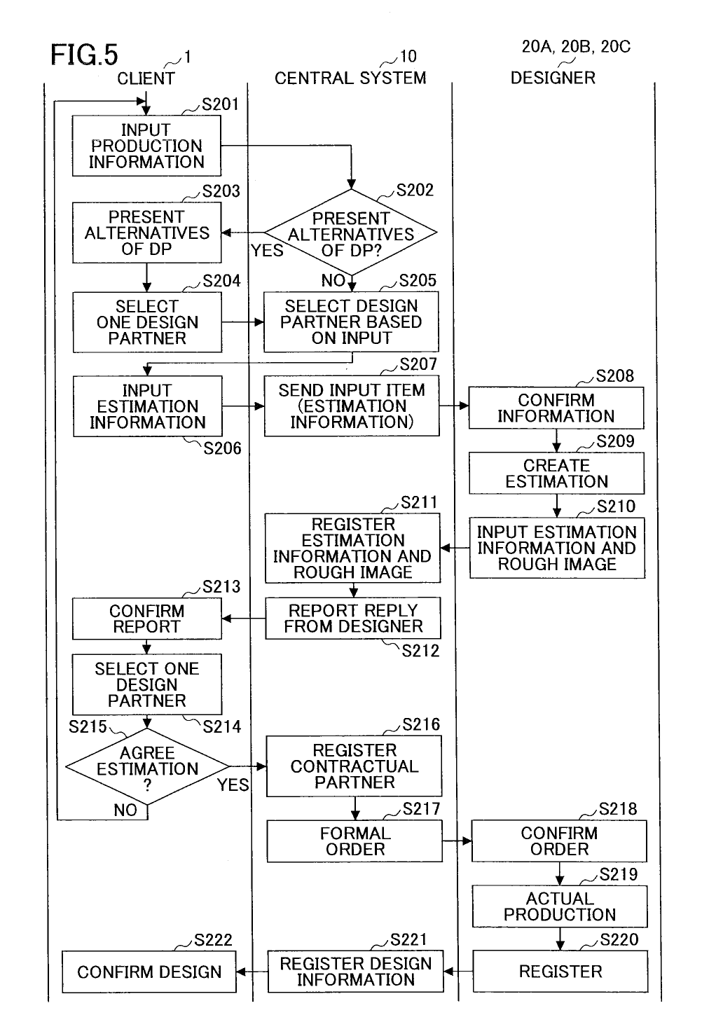

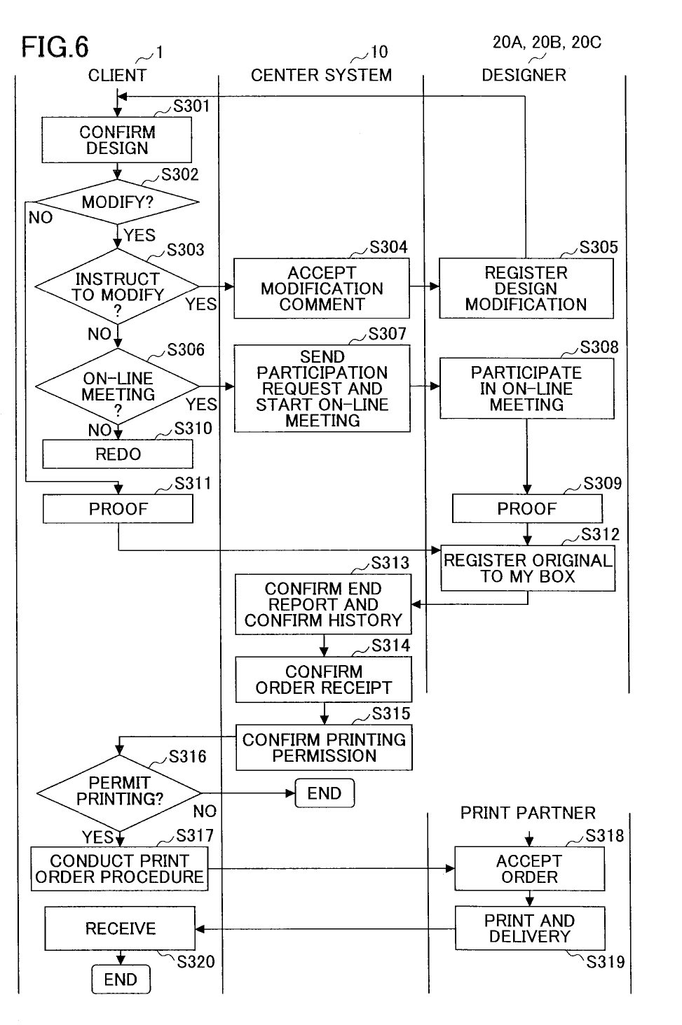

FIG. 4 and FIG. 5 are diagrams illustrating a flow of a process from the design partner determination to the estimation determination and a further process until confirmation of a first draft of a design. FIG. 6 is a diagram illustrating a flow of a process from confirmation of the first draft of the design to design printing. The flow in FIG. 6 describes association of the detailed design review and the printing after the first draft of the design is confirmed.

In a common process between the flow in FIG. 4 and the flow in FIG. 5, the client 1 sends one of the designers 20A, 20B, and 20C detailed created material information for the one to be able to create the design, when the formal order is made. In the flow in FIG. 4, the client 1 sends estimation information and apercu created material information for multiple design partner candidates to be able to create a rough image, to the multiple design partner candidates including the multiple designers 20A through 20C. Different from the flow in FIG. 4, the apercu created material information is sent to the one of the multiple design partner candidates, the one selected by the client 1, in the flow in FIG. 5. The detailed created material information is more detailed than the apercu created material information.

First, the flow will be described in a case of including the apercu created material information in an estimation request, sending the apercu created material information which is detailed so as to create the estimation information and the rough image, and taking competitive bids to select one design partner (FIG. 4).

With respect to FIG. 4, a flow of the estimation request (the client 1->the central system 10->the designers 20A, 20B, or 20C) is described below. In FIG. 4, the central system 10 begins from a state of providing the user interface to the client devices 20u. First, the central system 10 guides the client 1 to select what to create through the user interface. The client 1 selects a “created material” (not illustrated).

In response to the selection of the client 1, the central system 10 displays input items associated with the created material, and the client 1 fills the input items with desired information (or selects desired information) (step S101 in FIG. 4). A title, a purpose, a use method, a client type, a desired delivery date, and the like may be examples of the input items. Moreover, a size, color, an application, an indication method, a desired delivery date, and the like may be examples of items of detailed contents. These items may be changed depending on the created material being requested.

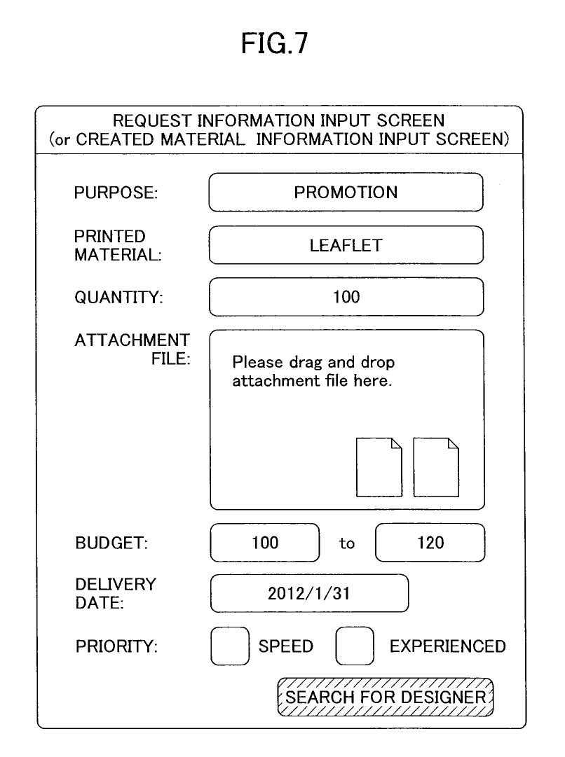

In step S101, the user interface to which the client 1 input information is called a “request information input screen”. An example of the request information input screen is depicted in FIG. 7.

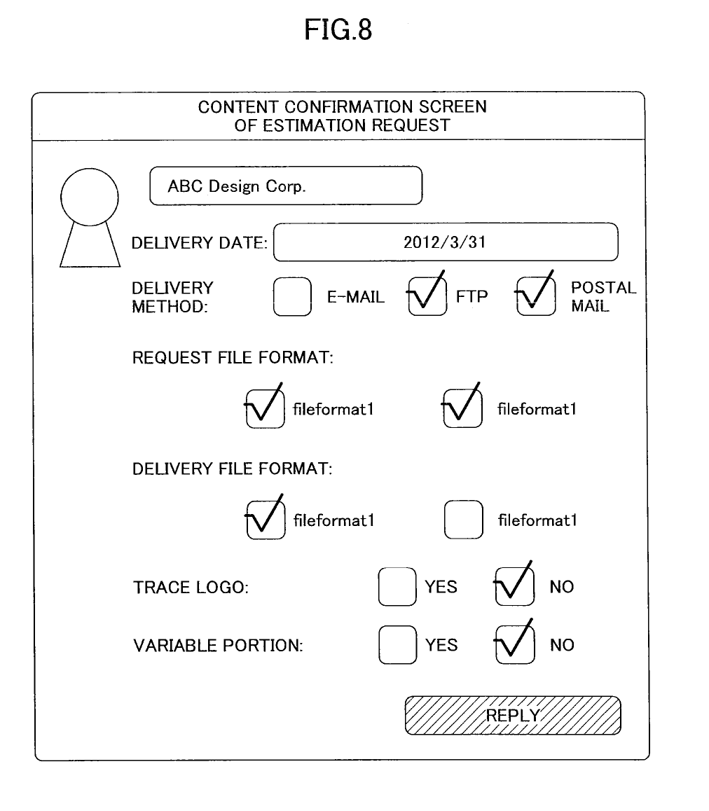

When the client 1 fills all necessary items and presses a confirmation button (not depicted), the central system 10 displays a content confirmation screen of the estimation request (FIG. 8). When the client 1 confirms, the estimation request for the design related to the created material is accepted. An example of the content confirmation screen of the estimation request is depicted in FIG. 8.

The estimation request sent by the client 1 includes information corresponding to the apercu created material information which is detailed so as to design the created material and is necessary to create the design. The apercu created material information corresponds to information which defines a requirement of the created material.

When receiving the estimation request, the central system 10 sends the information received by the estimation request, to a design partner being the designer 20A, 20B, or 20C. In this case, the information to transfer to the designer includes information of the client 1, information of the estimation request received from the client 1 and the created material associated with the estimation request, and information input to the input items associated with the created material.

In this case, one or more designers may be extracted by various conditions. The information may be transferred by e-mail or the like. A message of transferring the information may be displayed as a new arrival in a special design partner screen.

The central system 10 internally conducts a process for selecting the designer to send the estimation request based on input (step S102), and sends the input items (and the estimation request) to the selected designer (step S103). As described above, information of multiple designers may be extracted. In this case, the comparative bids are taken from the multiple designers.

Each of the multiple designers makes an estimation for the design based on the information which is transferred from the central system 10. Accordingly, the transferred information is required to be sufficient to create a rough image and make the estimation. Then, each of the multiple designers create the rough image based on the transferred information by their own technique (steps S104 through S106).

By continuously referring to FIG. 4, a transmission flow of the rough image and an estimation result (the designer 20A, 20B, or 20C->the central system 10->the client 1) will be described. In FIG. 4, when each of the designers registers the rough image and the estimation with respect to the central system 10, the central system 10 registers the rough image and the estimation (step S107).

It is preferable that the user interface provided to the designers includes a function to attach the rough image (an image file of a Joint Photographic Experts Group (JPEG) format or the like, a data file of a Portable Document Format (PDF), or the like), a text box to be an explanation field for the rough image, an input field to input estimation information (result). For example, the estimation information (result) may include a delivery date or total hours (man-hours), a cost, and other necessary items. The estimation information (result) is basically reported to the client 1 through the central system 10. Hence, there is no need to be concerned shipping an actual estimation.

The central system 10 retains information to display the rough image accepted from each of the designers and a set of additional information related to the rough image at the client device 20u of the client 1. In order to present the information to the client 1, the central system 10 may send the client 1 a message indicating that the rough image and the estimation result are registered, and leads the client 1 to a screen displaying the rough image and the like. The central system 10 may display the message as a new arrival on a personal page in the network 3. The rough image may be displayed as an attachment file. Alternatively, the rough image may be directly displayed at a screen to present to the client 1 (step S108).

In a case of sending the estimation request to the multiple designers, a special flow is preferably implemented. A time limit until the rough image is registered may be provided. The rough images may be displayed in a registration order. The rough image may be displayed after a certain time lapses. Other variations may be considered.

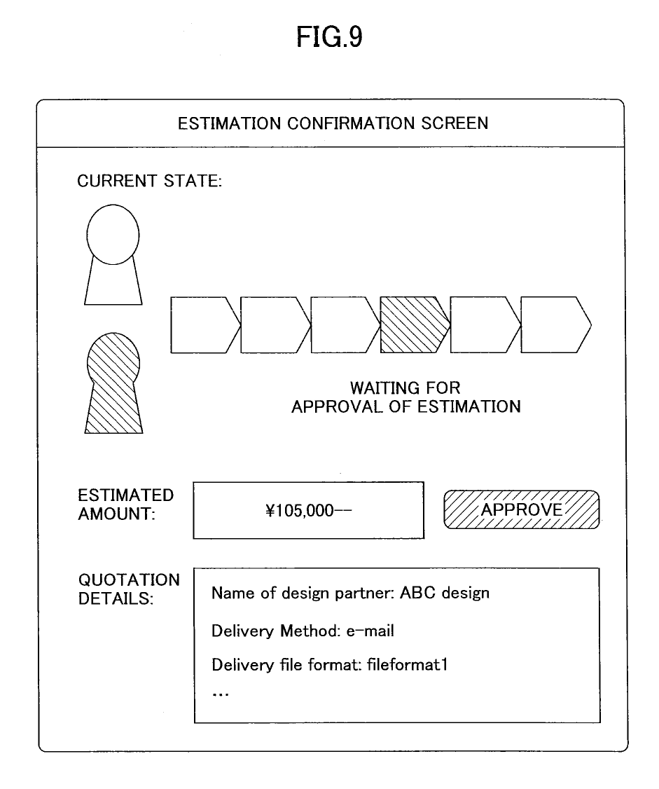

For the designers making the estimations, an estimation confirmation screen as illustrated in FIG. 9 may be displayed.

By continuously referring to FIG. 4, a report flow of confirmation of the rough image by the client 1 (the client 1->the central system 10->the designer 20A, 20B, or 20C) will be described. In FIG. 4, the client 1 confirms contents concerning each of the rough images created by the designers in which the rough images are registered to the central system 10 and reported to the client 1 (step S109).

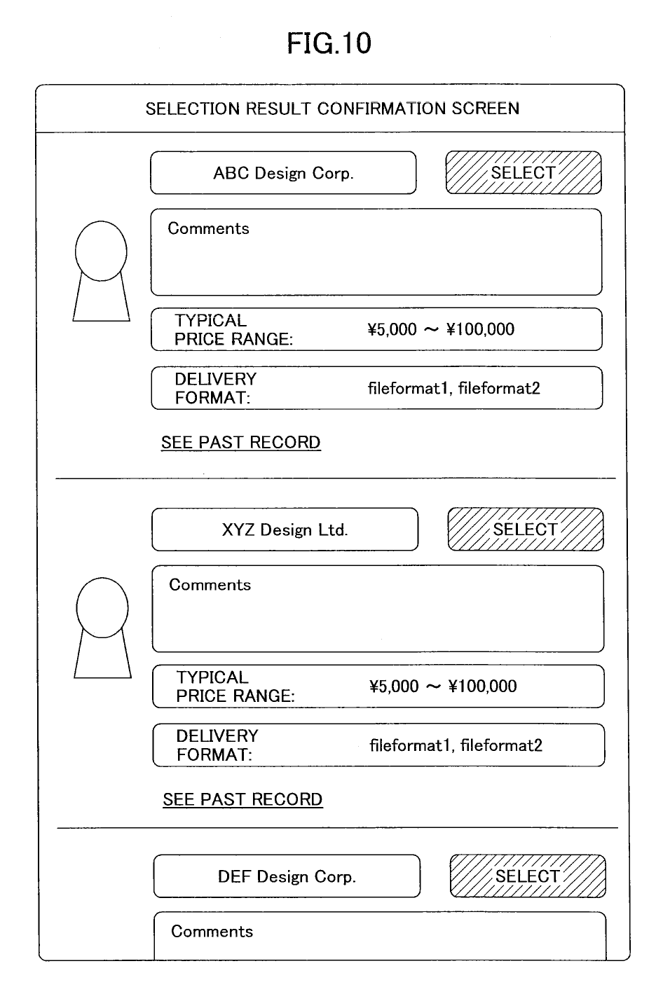

The central system 10 displays a “selection confirmation screen”, which is a user interface for the client 1 to select one of the designers replying with the estimations, at the client device 20u of the client 1. A confirmation button including a confirmation function is displayed in the selection confirmation screen. When the client 1 presses the confirmation button, a confirmation process by the client 1 is completed, and a message indicating that the client 1 confirms the estimation is sent to the central system 10. A comment input field may be provided with the confirmation button (steps S110 and S111). FIG. 10 illustrates an example of the selection confirmation screen.

The confirmation function may be cooperatively associated with an approval function. Thus, the confirmation function may be provided with a function for sending an approval request to a person having the right of making a settlement. Also, there is a case that an approval result indicates that it is not accepted. Hence, it is preferable to provide both a button to approve and a button to not approve. When the client 1 does not agree to the estimation (NO in step S111), the selection confirmation screen is transited to the request information input screen (FIG. 7).

When the button to approve is pressed by the client 1, the central system 10 receives information indicating the approval of the client 1 and comment information related to the information (YES in step S111). When the client 1 agrees to the estimation, estimation confirmation information, which indicates that the estimation is agreed, is sent to the central system 10. When a notice of an estimation agreement is received from the client device 20u, the central system 10 registers the designer being selected by this agreement to be a “contractual partner” (step S112).

After that, the central system 10 sends the information indicating the approval and the detailed created material information to the designer who presents the rough image and the estimation which are approved by the client 1. This is the formal order (step S113). The information may be sent and received by e-mail directly, or by reporting it in the special design partner screen which is provided by the central system 10.

The detailed created material information is regarded as information which defines a detailed requirement which is more than the apercu created material information which is sent to the designer selected by the client 1 through the central system 10 in step S101.

By continuously referring to FIG. 4, the confirmation by the designer and the creation and registration after that (the designer 20A, 20B, or 20C->the central system 10->the client 1) will be described.

The designer confirms the information indicating the approval of the client 1 by a report from the central system 10 (or at the special design partner screen to which the designer logs in). After the designer conducts a confirmation process (a confirmation flag is set to ON when the designer presses a button corresponding to the confirmation process) (step S114), the designer starts to create the design for the actual created material (step S115). When the designer enters a creation stage by pressing the confirmation button, the central system 10 receives information indication of a creation start, and may report the creation start of the designer to the client 1.

The designer basically creates the design based on the estimation presented for client 1. When the designer completes the creation of the design, the designer registers a deliverable design (step S116). The designer attaches comments for the deliverable design. As items for which the central system 10 displays, at least a function to register (a function to register as an attachment file), and a textbox to input text may be provided.

When the first draft of the design and additional information for the design are input to the central system 10, the central system 10 registers the first draft of the design and the information for the design (step S117). The central system 10 sends or reports a registration notice and the registered design to the client 1. The client 1 confirms the registration notice and the registered design (step S118). Thus, the first draft of the design is confirmed.

Next, a flow will be described in a case in which the designer is selected based on simple information pertinent to the created material, and the estimation request including the apercu created material information is sent to the selected designer (FIG. 5).

First, a flow of the estimation request (the client 1->the central system 10->the designer 20A, 20B, or 20C) will be described. In FIG. 5, the central system 10 starts a process from a state of providing the user interface to the client device 20u. The central system 10 guides the client 1 to select what to create through the user interface. First, the client 1 selects the “created material” (not depicted).

Since the central system 10 displays the input items related to the created material in response to the selection, the client 1 fills the input items with desired information (or selects the desired information) (step S201 in FIG. 5). The title, the purpose, the use method, the client type, the desired delivery date, and the like may be examples of the input items. Moreover, the size, the color, the application, the indication method, the desired delivery date, and the like may be examples of items of detailed contents. These items may be changed depending on the created material being requested.

In step S201, a user interface for the client 1 to input information is called a “created material information input screen”. An example of the created material information input screen is depicted in FIG. 7.

When receiving an input of created material information and an instruction of searching for the designer, the central system 10 first determines whether the multiple design partner candidates are presented as alternatives to the client 1 being the user (step S202). If the client 1 selects only one design partner, a screen for urging the client 1 to input detailed estimation information (NO of step S202, step S205, and step S206).

On the other hand, if the multiple design partners are presented as alternatives to the client 1, after the central system 10 presents the multiple design partners as the alternatives to the client 1, the central system 10 waits for a selection by the client 1, selects one designer based on the selection input by the client 1, and further presents a screen for urging the client 1 to input the detailed estimation information to the client 1 (YES of step S202, and steps S203 to S206).

The estimation information input in step S206 is regarded as the apercu created material information, and includes specific information necessary to create the design so as to start to create the design of the created material. The apercu created material information defines the requirement of the created material. FIG. 8 is a diagram illustrating an example of a screen for conducting content confirmation of the estimation information input by the designer.

When receiving an input of the estimation information, the central system 10 sends the received information to a designer (step S207). In this case, the information to send to the designer includes the information of the client 1, the information of the estimation request received from the client 1 and the created material associated with the estimation request, and the information input to the input items associated with the created material. The information may be sent by e-mail or the like. A message of sending the information may be displayed as a new arrival in the special design partner screen.

The designer estimates the design based on the information received from the central system 10. Thus, the received information is demanded to be of sufficient information to create the rough image and estimate the design. Then, the designer creates the rough image by his/her technique based on the received information (steps S208 through S210).

By continuously referring to FIG. 5, a flow of sending the rough image and estimation result (the designer 20A, 20B, or 20C->the central system 10->the client 1) will be described. In FIG. 5, when the designer registers the rough image and the estimation created with respect to the central system 10, the central system 10 registers the rough image and the estimation (step S211).

It is preferable that the user interface provided to the designers includes a function to attach the rough image (an image file of a Joint Photographic Experts Group (JPEG) format or the like, a data file of a Portable Document Format (PDF), or the like), a text box to be an explanation field for the rough image, an input field to input estimation information (result). For example, the estimation information (result) may include a delivery date or total hours (man-hours), a cost, and other necessary items. The estimation information (result) is basically reported to the client 1 through the central system 10. Hence, there is no need to be concerned about shipping an actual estimation.

The central system 10 retains information to display the rough image accepted from each of the designers and a set of additional information related to the rough image at the client device 20u of the client 1. In order to present the information to the client 1, the central system 10 may send the client 1 a message indicating that the rough image and the estimation result are registered, and lead the client 1 to a screen displaying the rough image and the like. The central system 10 may display the message as a new arrival on a personal page in the network 3. The rough image may be displayed as an attachment file. Alternatively, the rough image may be directly displayed at a screen to present to the client 1 (step S212).

In a case of sending the estimation request to the multiple designers, a special flow is preferably implemented. A time limit until the rough image is registered may be provided. The rough images may be displayed in a registration order. The rough image may be displayed after a certain time lapses. Other variations may be considered.

For the designers making the estimations, an estimation confirmation screen as illustrated in FIG. 9 may be displayed.

By continuously referring to FIG. 5, a report flow of confirmation of the rough image by the client 1 (the client 1->the central system 10->the designer 20A, 20B, or 20C) will be described. In FIG. 5, the client 1 confirms contents concerning each of the rough images created by the designers in which the rough images are registered to the central system 10 and reported to the client 1 (step S213).

The central system 10 displays the “selection confirmation screen”, which is a user interface for the client 1 to select one of the designers replying the estimations, at the client device 20u of the client 1. A confirmation button including a confirmation function is displayed in the selection confirmation screen. When the client 1 presses the confirmation button, a confirmation process by the client 1 is completed, and a message indicating that the client 1 confirms the estimation is sent to the central system 10. A comment input field may be provided with the confirmation button (steps S214 and S215). FIG. 10 illustrates the example of the selection confirmation screen.

The confirmation function may be cooperatively associated with an approval function. Thus, the confirmation function may be provided with a function for sending an approval request to a person having a right of making settlement. Also, there is a case that an approval result indicates not accepted. Hence, it is preferable to provide both a button to approve and a button to not approve. When the client 1 does not agree to the estimation (NO in step S215), the selection confirmation screen is transited to the created material information input screen (FIG. 7).

When the button to approve is pressed by the client 1, the central system 10 receives information indicating the approval of the client 1 and comment information related to the information (YES in step S215). When the client 1 agrees to the estimation, estimation confirmation information, which indicates that the estimation is agreed, is sent to the central system 10. When a notice of an estimation agreement is received from the client device 20u, the central system 10 registers the designer being selected by this agreement to be a “contractual partner” (step S216).

After that, the central system 10 sends the information indicating the approval and the detailed created material information to the designer who presents the rough image and the estimation which are approved by the client 1. This is the formal order (step S217). The information may be sent and received by e-mail directly, or by reporting it in the special design partner screen which is provided by the central system 10.

The detailed created material information is regarded as information which defines a detailed requirement more than the apercu created material information which is sent to the designer selected by the client 1 through the central system 10 in step S206.

By continuously referring to FIG. 5, the confirmation by the designer and the creation and registration after that (the designer 20A, 20B, or 20C->the central system 10->the client 1) will be described.

The designer confirms the information indicating the approval of the client 1 by a report from the central system 10 (or at the special design partner screen to which the designer logs in). After the designer conducts a confirmation process (a confirmation flag is set to ON when the designer presses a button corresponding to the confirmation process) (step S218), the designer starts to create the design for an actual created material (step S219). When the designer enters a creation stage by pressing the confirmation button, the central system 10 receives information indicating a creation start, and may report the creation start of the designer to the client 1.

The designer basically creates the design based on the estimation presented by the designer. When the designer completes the creation of the design, the designer registers a deliverable design (step S220). The designer attaches comments for the deliverable design. As items which the central system 10 displays, at least a function to register (a function to register as an attachment file), and a textbox to input text may be provided.

When the first draft of the design and additional information for the design are input to the central system 10, the central system 10 registers the first draft of the design and the information for the design (step S221). The central system 10 sends or reports a registration notice and the registered design to the client 1. The client 1 confirms the registration notice and the registered design (step S222). Thus, the first draft of the design is confirmed.

Next, the detailed design review conducted after the first draft is confirmed will be described with reference to FIG. 6. In FIG. 6, step S301 for confirming the design is the same as step S118 in FIG. 4 or step S222 in FIG. 5, and the explanation thereof will be omitted.

After the design confirmation, when the client 1 desires to modify (YES of step S302), the client 1 determines whether to conduct a modification instruction in accordance with a user interface screen for determining whether to conduct the modification instruction displayed at the client device 20u (step S303).

When conducting the modification instruction, the client 1 inputs the modification instruction on the user interface screen. As a result, since modification comments are sent to the central system 10, the central system 10 accepts the modification comments and sends those to the design partner (step S304). After the design partner modifies the design, the design partner registers the modified design (step S305). The modified design is to be confirmed again by the client 1 (step S301).

When the client 1 does not conduct the modification instruction, an alternative for starting an on-line meeting (step S306). In a case of starting the on-line meeting (YES of step S306), a notice of starting the on-line meeting is input and sent to the central system 10. When receiving the notice, the central system 10 sends a participation request of the on-line meeting to the design partner, and starts the on-line meeting (step S307).

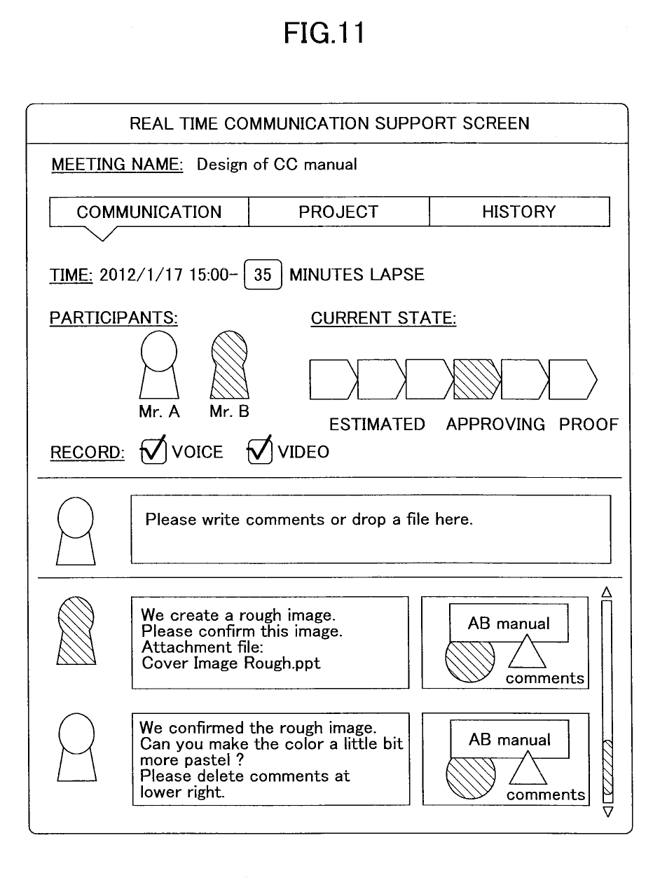

Any of the processes until the estimation, the creation of the first draft, and a design modification process (step S305) are not asynchronous processes, that is, they are not operations demanded simultaneously to the client 1 and the design partner. On the other hand, the on-line meeting is conducted by a synchronous process. The on-line meeting is also called “real time communication”. FIG. 11 is a diagram illustrating an example of a real time communication support screen.

By a real time interaction as illustrated in FIG. 11, a modification request and the design modification process are conducted, and then, the design is proofed (step S309).

Also, in a case in which it is determined that there is no modification (step S302) for the first draft or after an asynchronous design modification (the design modification process in step S305), the design is proofed (step S311).

In the following, association with printing will be described by continuously referring to FIG. 6. After the design proof, the electronic data concerning the design information are stored in the “MY BOX” which is described with reference to FIG. 3. The storage area in the print database 16, which is allotted for the client 1 ordering the design, is used for the “MY BOX” specific to the client 1.

The design partner uploads (registers) the electronic data (original) pertaining to proofed design information to the MY BOX (step S312). In a case of an upload, information of an end report of the design creation is attached with the electronic data and sent to the central system 10. The client 1 may upload the electronic data to the MY BOX.

The central system 10 confirms the upload and the end report of the design creation, and confirms the history (step S313). After that, the central system 10 accepts an order pertaining to a print of an original which is registered. When the central system 10 confirms order information (step S314), the central system 10 conducts a print allowable-or-not confirmation with respect to the client 1 (step S315). The print allowable-or-not confirmation may be made by a specific method for displaying a prompt inquiring the client 1 whether printing is permissible in the user interface displayed at the client device 20u used by the client 1.

When the client 1 confirms the printing of the design (YES of step S316), the client 1 conducts an order procedure of the printing from the MY BOX (step S317). The print order includes information for specifying a print partner who is to conduct printing. The central system 10 sends the print order to the print partner based on the information for specifying the print partner. On the other hand, the print partner accepts the print order (step S318).

The print partner, who accepts the print order, prints out the design and delivers the printed materials. Specifically, the print partner downloads, to the print system 21, the electronic data concerning the design information being proofed which is stored in the MY BOX, and performs the printout based on the electronic data.

The printed material is delivered to the customer 2 of the client 1 (the printed material may be delivered to the client 1, instead) (step S320). As described above, it is possible for the client 1 to acquire the printed material of the design which is created based on consensus settled by multiple stages between the client 1 and one of the design partners A1, A2, A3, . . . so that the client 1 is satisfied.

In the embodiment, the central system 10 selects an appropriate design partner for the client 1 who desires the printout. Next, the central system 10 conducts the estimation request to the selected design partner. Then, the central system 10 accepts the estimation confirmation information presenting whether the client 1 agrees to the estimation, with respect to the estimation as a reply of the selected design partner. The consensus is settled based on the estimation confirmation information. Moreover, if necessary after the estimation is agreed, the design modification process is conducted synchronously by the on-line meeting.

Furthermore, the design information is retained at a side of the central system 10. When a print output instruction is made by the client 1, the electronic data pertaining to the design information is allowed to be downloaded in response to a download request from the print system 21 corresponding to the print output instruction.

According to the embodiment, in the central system 10 for intermediating the client 1 and each of the designers 20A, 20B, and 20C, it is possible for the client 1 and the designers 20A, 20B, and 20C to create the printed material of the design which the client is satisfied and by the consensus settled between them by the steps.

In the embodiment, a client application, which displays the user interfaces for the client 1, may be installed into the client device 20u. A client application, which displays the user interface for the design partners A1, A2, and A3, is installed into each of the client devices 20a, 20b, and 20c. However, these configurations may not be applied in a case in which the user interfaces of the cloud printing system are implemented by the Web application.

According to the embodiment, the communication between the client 1 and the design partners A1, A2, A3, . . . is conducted by multiple steps, so as to eliminate instability in which information is changed depending on how to comprehend the design. It is possible to pass the design from the client 1 to the designers 20A, 20B, and 20C at a creator side. In communication in the multiple stages, by presenting information necessary in time (at each of the multiple stages), it is possible to eliminate misconceptions. Also, a detailed depth of the information necessary for the design creation becomes more refined step by step, and the client 1 is made to input information multiple times. Thus, it is possible to easily transfer a concept of a desired design, which would have been conventionally difficult to meet the requirement of the client 1.

Also, it is possible to realize an association for outputting a design result, which is acquired as an achievement of the design creation as described above, as the printed material. In the related art, such association has not been considered.

According to the embodiment, it is possible to provide the printed material creation support apparatus in which the consensus is settled by multiple stages between the client 1 and any of the designers 20A, 20B, and 20C, and the printed material of the design which the client is satisfied is acquired.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device.

The computer software can be provided to the programmable device using any storage medium for storing processor readable code such as a floppy disk, a hard disk, a CD ROM, a magnetic tape device or a solid state memory device. The storage medium may be a non-transitory (or tangible) computer-readable recording medium.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made hereto without departing from the spirit and scope of the invention.

This patent application is based on Japanese Priority Patent Applications No. 2012-061438 filed on Mar. 19, 2012 and No. 2012-061441 filed on Mar. 19, 2012, the entire contents of which are hereby incorporated herein by reference.

What is claimed is:

1. A printed material creation support apparatus comprising:
a user interface providing part configured to provide an input user interface to a client;
a design partner selection part configured to select a first design partner from multiple design partners based on created material information which the client inputs to the input user interface;
an estimation process part configured to send apercu created material information defining a first requirement of the created material to the first design partner selected by the design partner selection part, to receive estimation result information made by the first design partner, and to send the estimation result information to the client;
a consensus settlement support part configured to receive estimation confirmation information from the client and to settle consensus based on the estimation confirmation information; and
a design modification part configured to synchronously reflect modifications of the first design partner with a modification indication of the client with respect to design information created based on detailed created material information which is received from the client after the consensus is settled for an estimation and defines a first detailed requirement which is more than the apercu created material information.

2. The printed material creation support apparatus as claimed in claim 1, wherein
the design partner selection part selects multiple first design partners, and
the user interface providing part displays information of the multiple first design partners selected by the design partner selection part to the client, and provides the input user interface for the client to select one of the multiple first design partners.

3. The printed material creation support apparatus as claimed in claim 1, further comprising a modification comment accept part configured to accept the modification instruction of a design from the client, and to send the modification instruction to the first design partner with whom the consensus is settled.

4. The printed material creation support apparatus as claimed in claim 1, further comprising a print database configured to store electronic data pertaining to the design information being proofed, and to accept a download request of the electronic data externally from a print system in response to a print request of the client.

5. The printed material creation support apparatus as claimed in claim 4, wherein the design partner selection part selects the first design partner, who creates a design, from the multiple design partners based on estimation information which defines a second detailed requirement of the created material in addition to the created material information.

6. The printed material creation support apparatus as claimed in claim 4, wherein the design partner selection part selects multiple design partner candidates, and sets one or more from the multiple design partners candidates by the client as the design partners to be selected.

7. A printed material creation support method performed in a computer, the method comprising:
providing an input user interface to a client;
selecting a first design partner from multiple design partners based on created material information which the client inputs to the input user interface;
sending apercu created material information defining a first requirement of the created material to the first design partner being selected, receiving estimation result information made by the first design partner, and sending the estimation result information to the client;
receiving estimation confirmation information from the client and settling consensus based on the estimation confirmation information; and
synchronously reflecting modifications of the first design partner with a modification indication of the client with respect to design information created based on detailed created material information which is received from the client after the consensus is settled for an estimation and defines a first detailed requirement which is more than the apercu created material information.

8. The printed material creation support method as claimed in claim 7, further comprising
storing electronic data pertaining to the design information being proofed; and
accepting a download request of the electronic data externally from a print system in response to a print request of the client.

9. A carrier medium saving a program representing a sequence of instructions, the program which when executed by a computer included in a printed material creation support apparatus, supports creation of a printed material, the instructions cause the computer to function as
a user interface providing unit which provides an input user interface to a client;
a design partner selection unit which selects a first design partner from multiple design partners based on created material information which the client inputs to the input user interface;
an estimation process unit which sends apercu created material information defining a first requirement of the created material to the first design partner being selected, receiving estimation result information made by the first design partner, and sending the estimation result information to the client;
a consensus settlement support unit which receives estimation confirmation information from the client and settling consensus based on the estimation confirmation information; and
a design modification unit which synchronously reflecting modifications of the first design partner with a modification indication of the client with respect to design information created based on detailed created material information which is received from the client after the consensus is settled for an estimation and defines a first detailed requirement which is more than the apercu created material information.

10. The carrier medium as claimed in claim 9, wherein the instruction further causes the computer to functions as an accept unit which stores electronic data pertaining to the design information being proofed; and accepts a download request of the electronic data externally from a print system in response to a print request of the client.
